(19) United States
(12) Patent Application Publication
(10) Pub. No.: US 2002/0166000 A1
(43) Pub. Date: Nov. 7, 2002

(54) Method for inverting program control flow

(76) Inventors: Markku Rossi, Jarvenpaa (FI); Jukka Raanamo, Helsinki (FI)

Correspondence Address: PILLSBURY WINTHROP, LLP, P.O. BOX 10500, MCLEAN, VA, 22102, US

(21) Appl. No.: 10/103,145

(22) Filed: Mar. 22, 2002

(30) Foreign Application Priority Data
Mar. 22, 2001 (FI) 20010592

(51) Int. Cl. G06F 9/46; G06F 9/00

(52) U.S. Cl. 709/328; 709/107

(57) ABSTRACT

A method of application program (AP) execution within a computer system (S) comprising an operating system (OS) providing an interface to external events. The operating system is essentially unmodifiable by the application programmer. The application program (AP) has at least one high-level language application program module which is modifiable by the programmer. The operating system (OS) controls the computer most of the time and only intermittently dispatches control to the high-level module, whereby the execution of the application program module is not sequential. The method comprises creating (3-2) a thread for execution; detecting (3-4) a need for an asynchronous operation; in response to a detected need, suspending (3-6) the thread's execution; detecting (3-8) completion of the asynchronous operation; and in response to a detected completion of the asynchronous operation, resuming (3-10) the thread's execution. The invention creates an illusion of sequential execution within the high-level language application program module. The method is preferably implemented by an application interpreter (Al) such as a modified programming language.

### BACKGROUND OF THE INVENTION

The invention relates to programming methods, application programs, program interpreters and equipment for providing network services and testing software and/or hardware modules.

The invention is intended for use in environments where a program module operates by receiving messages, events or calls (collectively called “callbacks”), performs some processing in response to the callbacks, and then returns control to the outside of the program module. Such program modules are ubiquitous in network server applications, in which a typical example of such a program module is the part of a network server that processes received requests and sends replies. Another example is object-oriented programming wherein a class may be such a module. When class methods are called, they perform some processing, and then return control to the outside of the class. Yet another example is a graphical user interface where the program typically has an event loop that receives messages (such as mouse clicks) from the user, and calls appropriate handler functions that process the message and then return control to the event loop. A characteristic feature of such modules is that they receive program control flow from outside the module, perform some processing (possibly temporarily passing control to the outside of the module via a function call, but receiving the control back immediately when the function returns), and then return control to the outside of the module without knowing when (if ever) the module will again receive control.

FIGS. 1 and 2 illustrate the concepts of top-down and bottom-up programming, respectively. The left-hand side of FIG. 1 illustrates the basic steps of top-down programming. This paradigm is intuitively familiar to people with little or no programming experience. In this paradigm, the programmer has the feeling of having complete control of the program and the hardware resources of the computer. Unfortunately, the top-down programming paradigm shown in FIG. 1 is not suitable for multi-tasking environments when asynchronous operations are needed. An asynchronous operation is an operation whose duration is not controllable or predictable by the programmer. Examples of asynchronous operations include the completion of a hardware operation, the arrival of a network message, and user input (such as mouse clicks and keystrokes). If the program must wait for an asynchronous operation to complete, all parallel processes are stalled. This is why in a multi-tasking environment, programmers must resort to another programming paradigm shown in FIG. 2, namely bottom-up or event-driven programming. In this paradigm, an application program AP cannot be written as a simple flowchart like the one shown in FIG. 1. Instead, the application program AP must communicate with the underlying operating system OS by means of event handlers. In the scenario shown in FIG. 2, the operating system OS gives only intermittent control to the application program AP via an event handler EH1, which performs a function call FC1. Function call FC1 in turn performs other function calls through FCn, until an asynchronous operation AO is reached. The branch beginning with event handler EH1 is unwound, which means that the program stack frames relating to the branch no longer exist and cannot be used for preserving state information concerning that branch. When the asynchronous operation AO is completed, the operating system OS again passes control to the application program AP, this time via another event handler EH2.

The application program may also call the operating system from the branches, but such calls must return quickly, because otherwise the application cannot process other messages or incoming connections. This means that incoming data packets or user input may be lost, for example. Modal dialogs try to get around this problem by using their own event loops that poll messages from the operating system and dispatch them. For various technical reasons, this is not a widely used solution in network server applications. Some applications use multiple threads to process messages, whereby they can process several messages simultaneously, but each thread still exhibits similar control flow behavior as if there was only one thread.

Thus, in a bottom-up programming environment, an application program or module does not control the overall execution. The program or module only sees the branches that reach it from the operating system. A problem is that an application programmer has no control over the trunk (the operating system) from which the branches leave. Apart from the fact that different programmers or system users may install different modules and change certain system settings, the operating system cannot be chosen or modified by the programmer. In other words, the operating system is essentially unmodifiable by the programmer. However, experience has shown that people understand programs much more easily if they can view the part of the program they are working on as the trunk, and have execution branches leaving from the trunk and returning to it.

Many tools are available for supporting the development of graphical user interfaces. For example, C++ and Java class libraries are widely used to reuse previously written software components. Even more importantly, all modern graphical user interface toolkits allow the user to use modal dialogs. A modal dialog, as used herein, means a technique in which a server application displays a page (or a part of it, such as a window, pane or form) to a client, and the server application does not continue until the client dismissed the page. Modal dialogs are typically displayed by using a function call which does not return until the dialog has been closed (usually as a result of the user clicking an “Ok” or “Cancel” button). Such modal dialogs are often implemented by a user interface toolkit by explicitly disabling the operation of other windows in the application (or by grabbing all user interface messages to the dialog window), and then running a nested event loop in the modal dialog function. An event loop is a piece of program code that reads events and dispatches them to window-specific message handlers. Each such message handler would typically be a program module that behaves as described earlier, in connection with the definition of “callbacks”. Modal dialogs can be application-modal or globally modal, depending on whether they allow other graphical applications running on the same display device to continue receiving events. The concept of modal dialogs was instrumental in making graphical user interfaces easy enough to write for ordinary programmers so that the current base of graphical applications could be written.

However, the modal dialog concept has not been available for network servers, mainly because the primary page-description language, HTML, does not support modal dialogs. With e-commerce being increasingly conducted over the world-wide web (WWW), network server applications are becoming increasingly complex, and are increasingly resembling normal graphical applications in respect of their user interfaces. However, no methods are known for implementing the equivalent of modal dialogs in network servers.

### DISCLOSURE OF THE INVENTION

An object of the invention is to invert the programming flow control from the bottom-up paradigm to the top-down paradigm, or at least create an illusion of such a flow-control inversion. Such a flow-control inversion could be used to implement modal dialogs in network servers. This object is achieved with a method and equipment which are characterized by what is disclosed in the attached independent claims. Preferred embodiments of the invention are disclosed in the attached dependent claims.

The invention will be presented in the form of three principal aspects which relate to specific ways of exploiting the invention.

One aspect of the invention is a method of high-level application program execution within a computer system having an operating system which provides an interface to external events. The operating system is essentially unmodifiable by the programmer of the application program but the application program is modifiable or has at least one module which is modifiable by the programmer. The operating system controls the computer system most of the time and only intermittently dispatches control to the high-level application program/module. Thus, the execution of the application program module is not sequential.

According to the invention, the method of high-level application program execution comprises creating an executable thread for the high-level language application program module, suspending the thread's execution when waiting for an external event; and resuming the thread's execution in response to the external event.

Another aspect of the invention is a method for testing hardware and/or software modules having at least one asynchronous interface with asynchronous function calls. According to the suspended-thread approach of the invention, the method for testing hardware and/or software modules comprises creating an executable thread for the test operation, suspending the thread's execution when a test operation is started; and resuming the thread's execution when the test operation is completed.

Yet another aspect of the invention is a programming environment, such as a programming language/toolkit, for implementing the state-preserving acts according to the invention. The state-preserving acts comprise the steps of suspending a thread's execution before and external event and resuming the thread's execution in response to the completion of the external event. The programming language is preferably based on the Java language. A Java virtual machine can be equipped with support for thread suspension with relative ease, and Java is extensively used in web applications.

It should be stressed that in known programming environments, the top-down and bottom-up paradigms are mutually exclusive, and the programmer cannot choose which paradigm to use. Instead, the decision is dictated by the environment. However, the invention creates an apparent inversion of the control flow from the event-driven bottom-up paradigm to the application-controlled top-down paradigm which is a much more programmer-friendly environment. A general technical effect caused by the paradigm inversion is a decrease in the expected number of program errors, because the logic of the program follows much more closely what the programmer intends to achieve. Further technical effects are to be gleaned from the descriptions of the various embodiments.

Thus the invention is based on a vision that, although it is probably not possible to invert the flow control from the bottom-up paradigm to the top-down paradigm, for most practical purposes it is sufficient to create an illusion of such a flow-control inversion.

Many software systems, such as graphical user interfaces, network servers, and message-passing systems, are advantageously implemented using an event-driven programming style. In fact, most or all popular graphical user interface systems (Microsoft® Windows, Apple® Macintosh, and the X11 interface by the X Consortium) use this style. The server software for some of the most popular networking protocols (e.g. HTTP (Hyper Text Transfer Protocol) and WAP (Wireless Application Protocol) are also usually written using this style. However, the event-driven programming style forces applications to be written as event handlers, without any consistent flow control across the application. This makes the development of complex application programs for graphical user interfaces and network servers quite difficult and error-prone. An advantage of the invention is that an application program programmed in a high-level language can be written as if it had full control of the program flow (top-down control), even though in reality the program execution is driven by low-level events that call high-level functions which perform a small amount of work and then return (bottom-up control or event-driven programming, or callback-based programming).

The invention will simplify the development of web-based and e-commerce applications and enable powerful tools to be developed for building such applications. Further, the invention can be used for applications such as software testing, protocol testing, and telecommunications system testing. Thus the invention allows the intuitive and familiar top-down paradigm to be used for such applications, which is likely to improve programmer productivity and software quality in the long run.

The invention provides a mechanism for the sequential execution of an application program written in a high-level programming language in an environment in which the module that executes the program is called in response to external events, after which it needs to return control to the out-side of the module to receive additional events. Examples of such external events include network messages, mouse clicks, keyboard strokes, the completion of an operation and the expiration of a timer.

If we examine typical physical execution flow of a processor, it probably loops somewhere, most likely inside the operating system, waiting for something to do, then signals an event to a particular application by switching to the application's execution context (for example by means of virtual memory mappings), and returns the execution to the application. It is assumed that the application has previously given control to the operating system either via a blocking system call or a context switch. The operating system may return some data to the application as part of the return from the system call. The application then examines the data, and dispatches the received message (user interface message, network connection, or network packet) to the appropriate function within the application. That function may further dispatch the message, or may itself process the message. Eventually, the message is processed (possibly by deciding to ignore it), and the control is returned back to the dispatching function. At its lowest level, the application program most likely passes the control back to the operating system by calling a system call that blocks (does not return until the next message has been received).

The invention allows the application programmer to write a piece of code as if the code was the only one in the system and in full control of the execution. For example, the program may contain constructs such as “display a dialog”, and “continue when done”, or it may display a page to the client in a web application, and continue when the user clicks a button.

It should be noted that the control flow inversion is only an apparent one, because it is not possible to change the physical structure of the control flow. The underlying operating system and protocols dictate how control is organized at the lower levels, and it may not be even theoretically possible to organize it otherwise. At least, no known solutions exist. However, the invention gives the application program the illusion that the program is running sequentially, in a top-down fashion. To the programmer it does not matter that this is only an illusion; the program behaves as if it was real. Thus, the invention creates the illusion that the application program is running sequentially and is in complete control of the program control flow. In reality, the application program is executed a small piece at a time, and when the application program cannot execute any longer (it cannot continue until a lower-level event occurs, which means that physical execution must return), the program saves its execution state by suspending the relevant thread, saves a reference to the saved execution state in a storage location, and returns. When a suitable event occurs that allows the program to be continued, the execution is continued by retrieving the saved execution state from the storage location and allowing the thread's execution to continue.

According to the suspended-thread approach of the invention, the illusion of program control flow inversion is created by a novel way of processing threads. This approach operates by creating a thread for each session. In object-oriented programming environments, the thread is implemented as a thread object. Thread objects per se are disclosed in [KIShSm96, see the list of references at the end of this specification]. At the beginning of a new session, a thread is created for it. When the thread outputs a page to the client, the thread is suspended. In other words, its execution is blocked, for example by waiting for a “mutex” (mutual exclusion lock) or a condition variable to be signaled. When a new request for the same session is received, the request is stored in the session context, such as the session object, and the execution of the session's thread is continued by signaling the mutex or condition variable. The fact that the new request relates to an existing session can be determined on the basis of a session identifier comprised by the request. In this way, modal dialogs in web applications can be implemented by storing implicit context information in the stack of each thread and by blocking (suspending) the thread between requests. When a new request for the same session is received, execution of the session's thread continues until the next page is output to the client and the thread is blocked again.

A queuing mechanism can be used to limit the number of simultaneous threads that can exist in the server system. When the allowed maximum number of simultaneous threads is about to be exceeded, one or more threads can be deleted from the system. For example, the threads to be deleted can be selected on the basis of a least-recently-used (LRU) algorithm or a more complex algorithm that weighs or prioritizes acts, users etc..

At this stage, the description of the suspended-thread approach is not tied to any specific programming language, but examples in the Java language will be presented later. The following description of the preferred embodiments of the invention relies on the concept of objects, such as in the term ‘session object’. In non-object-oriented environments, the concept of ‘object’ can be replaced with suitable context information.

Let us first assume that a client's request identifies a session by using a special part in the URI (Uniform Resource Indicator). When the first request for a new session is received (a matching existing session is not found), an identifier for the new session is created and the session identifier is included in all outward links which are generated as a result of processing the session in question. Alternatively, cookies or IP addresses can be used as session identifiers.

The server system has a data structure that contains all session objects. This data structure may take the form of a LRU list, for example. The LRU list can be implemented as a doubly-linked list where an object is moved to the front of the list whenever it is accessed, and objects are deleted from the tail (back) of the list as needed. Alternatively, the data structure may be or comprise a structure optimized for searching, such as a hash tree or a balanced tree, which are well known to those skilled in the art.

Each session object (or search structure associated with the session object) contains or indicates the session identifier used to find the correct session object whenever a request for the session is received.

Each session object contains a thread object. Whenever a session object is created, the corresponding thread object is created and stored in the session object. It is also possible to have the thread object only if the session is in the middle of a modal operation. The latter mode of operation is more efficient in that a session object can maintain a count of nested modal dialogs and only contain the full thread object if the count is nonzero.

Each session object also contains a mutex object. The mutex object can be any kind of lock or synchronization primitive, such as a condition variable, semaphore or monitor. The mutex object is used to block the execution of the thread (and the session) when the session is waiting for a response from the client. As a yet further alternative, the mutex object or lock may not be needed, and the thread can block its own execution by calling a thread_suspend function. In this implementation, the server system calls a thread_continue function to resume execution in response to receiving the next request for the session. Having a thread to suspend its own execution is notsupported by all programming languages, however.

The server operations in response to receiving a request can be presented in the form of the following pseudocode:

Listing 1

1. Does the request indicate an existing session?

2. If not: create a new session object (delete old ones if there are too many)

3. If yes:

look up the session object corresponding to the request

store the request (or some of it) in the session object

allow the thread of the session to continue.

In the above example, it was assumed that each session object has a thread object associated with it. The technique can be optimized by maintaining a thread object only when the session is waiting for a response to a modal dialog and releasing the thread object if the session does not display a modal dialog.

Each session thread would perform substantially as follows:

Listing 2

1. get request data from the session object

generate output as indicated by the request data

(eg close the output connection)

suspend myself

goto 1

If the thread executes a modal dialog, the core of the modal dialog function performs as follows:

1. generate output for the modal dialog

(eg close the output connection)

suspend myself

get request data from the session object

shall the modal dialog be closed?

If not: goto 1

If yes: return to normal processing

It is apparent that the request data can also be stored in any of a number of places, such as in a global variable, in thread-local storage or in a separate object linked to the session object.

The layout for the modal dialog can be generated by using any known technique, such as having it generated by a programming language, evaluating the contents of special tags and the like.

### BRIEF DESCRIPTION OF THE DRAWINGS

The various approaches and aspects of the invention will be described in more detail by means of preferred embodiments with reference to the appended drawings wherein:

FIGS. 1 and 2 illustrate the concepts of top-down and bottom-up programming, respectively;

FIG. 3 illustrates the principle of the thread-suspension approach of the invention;

FIG. 4 illustrates a smartcard testing application; and

FIG. 5 shows a program listing for the smartcard testing application shown in FIG. 4; and

FIG. 6 illustrates a prior art web server application;

FIG. 7 illustrates a web server application according to the invention;

FIG. 8 illustrates two pages of a modal dialog;

FIGS. 9 to 14 are program listings for the web server application shown in FIG. 7.

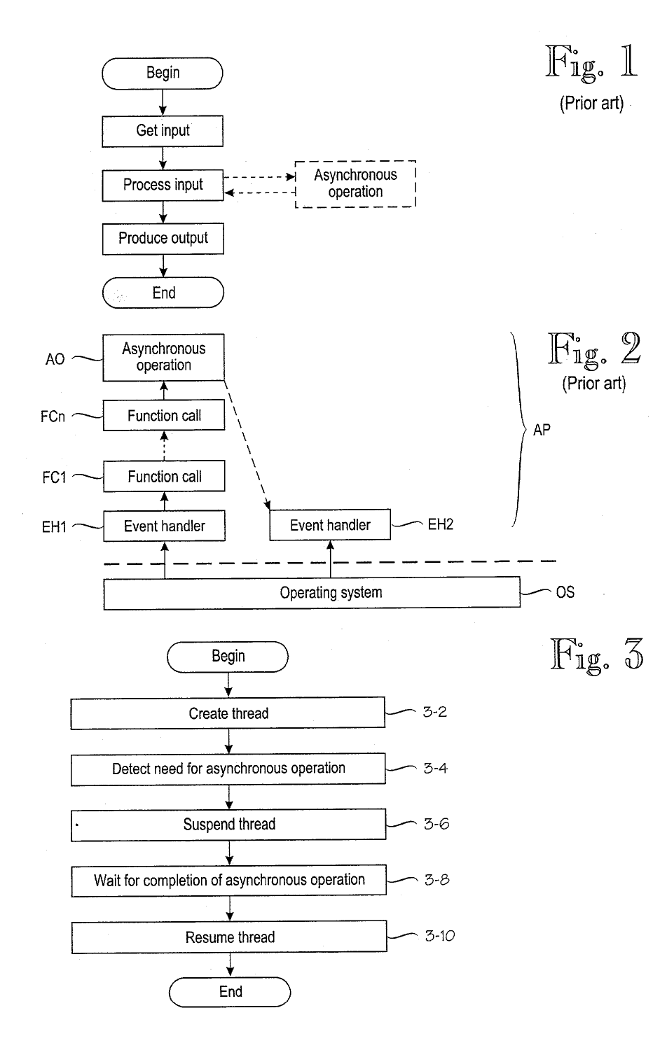

### DETAILED DESCRIPTION OF THE INVENTION

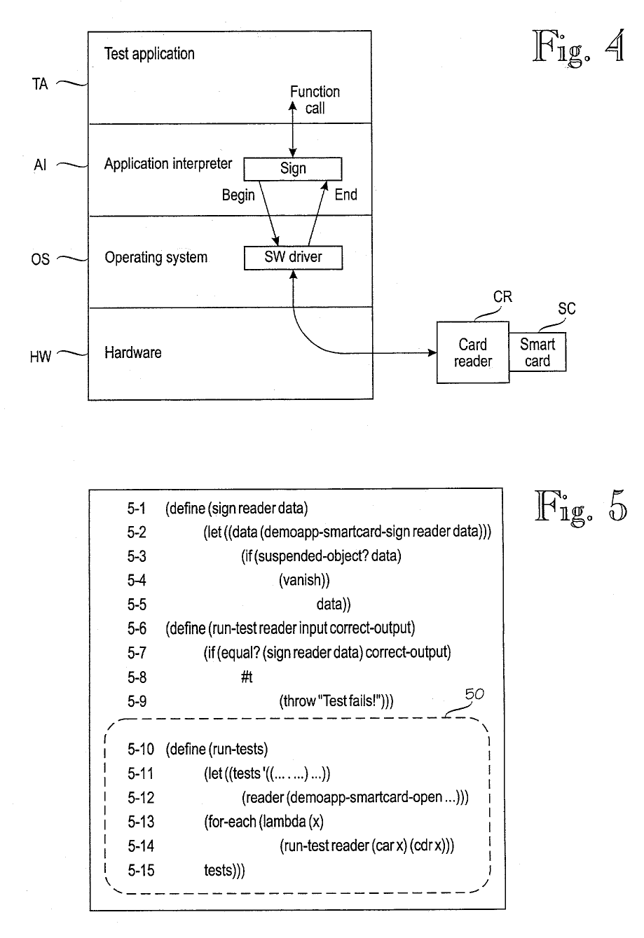

Two practical applications for the invention will be described. FIG. 4 illustrates a smartcard testing application. Cryptographic smartcards typically contain a secure operating system, some memory, and a cryptographic accelerator function. The cryptographic accelerator function performs a digital signature operation on the smartcard. Using current technology, the signature operation typically takes one to two seconds.

Because the signature operation is relatively slow, it is often desirable to provide an asynchronous interface to the smartcard. This means an interface in which the application program initiates the signature operation, but the call returns immediately, and the asynchronous interface calls a separate callback function when the signature operation is complete. The processor may perform other, completely unrelated tasks in the meantime.

It is a surprisingly difficult task to write a test program for an asynchronous smartcard reader in a multitasking environment. This is because the programmer needs to implement the callback functions that are called when the operation is complete, and to start the next test from the callback. This task is further complicated if there is more than one smartcard reader in the system and the driver is to be tested with several readers in parallel.

In the embodiment shown in FIG. 4, a computer comprises hardware HW, an operating system OS and a test application TA. The test application is interfaced to the operating system with an application interpreter Al according to a preferred embodiment of the invention. The application interpreter implements the state-preserving function calls according to the invention. The computer is connected to a card reader CR for reading and writing a smartcard SC. For the purposes of this description, it suffices to say that a smartcard is a card which comprises a processor.

FIG. 5 shows how the invention allows the test application to be written as a simple sequential program. The example in FIG. 5 uses the Scheme programming language. In this example, the “run-tests” function defined on line 5-10 executes a number of tests (calls to the “run-test” function defined on line 5-6) using sequential iteration (the “for-each” control structure on line 5-13). The “demoapp-smartcard-sign” function on line 5-2 is internally a function written in the C programming language, and it uses an asynchronous interface to the smartcard driver. The driver interface calls a supplied C call-back function with a supplied argument when the signature operation is complete. The “demoapp-smartcard-sign” function allocates a memory block, suspends the thread for the current Scheme execution state in the memory block, and arranges for the address of the memory block to be passed as the argument to the C callback function defined in the smartcard driver interface. The “demoapp-smartcard-sign” function then returns a special Scheme object called “data” for which the “suspended-object?” function on line 5-3 returns a value of true. The “vanish” function on line 5-4 causes the current Scheme execution to terminate, and control returns to an event loop while the signature operation to the smartcard is being performed. An arbitrary number of other callbacks, including eg network protocol message handling or calls to other Scheme functions, may occur during this time. Thus the “demoapp-smartcard-sign” function has already returned once, but the entire Scheme execution was terminated in this case as a result of calling the “vanish” function immediately thereafter.

When the signature operation is complete, the C callback function is called. The callback function uses the argument to find the memory block, restores the execution of the suspended thread so that the return value of the signature operation is returned as the return value from the “demoapp-smartcard-sign” call. Thus, the “demoapp-smartcard-sign” function returns for a second time. This time the “suspended-object?” function returns a false value. The programmer has an illusion that the test program shown in FIG. 5 was running sequentially. It can also be said that the invention synchronizes the asynchronous operations relating to external events.

In FIG. 5, reference numeral 50 depicts a program module according to the invention. The actual execution of the module 50 is not sequential, but the module and its programmer are provided with an illusion of sequential execution.

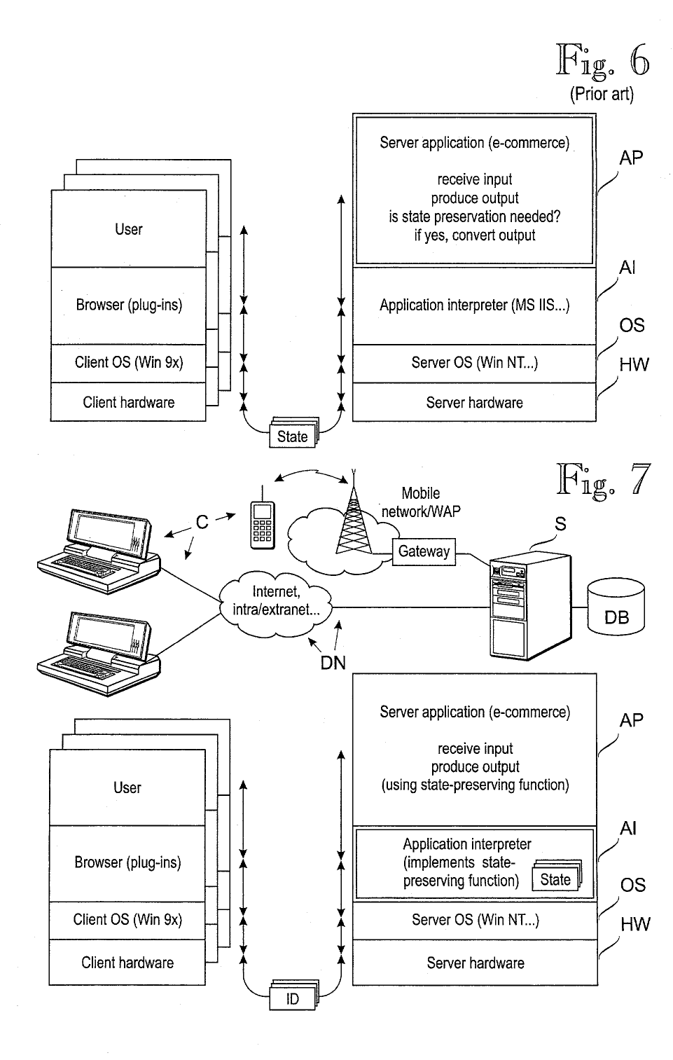

FIGS. 6 and 7 illustrate how the invention can be used to implement services in a web or wap server application. FIG. 6 shares the hardware section with FIG. 7. FIG. 6 shows a prior art arrangement for a web application. In this example, several client terminals C (computers, mobile phones or the like) are connected via a data network DN to a server S which employs a database DB. In heavy-duty applications, the server S is typically implemented as one or more communication servers and one or more transaction servers, but such hardware details are not relevant for understanding the invention. The data network DN is typically an IP (Internet Protocol) network, such as the Internet, an intranet or extranet, or a mobile network with wireless application protocol (wap). Each client terminal C comprises hardware, a client operating system and a network browser by which the user accesses various services provided by the server S. The server S comprises hardware, a server operating system, an application interpreter and server application software.

A web server listens for requests using the HTTP protocol. A web application interacts with the user using a sequence of several request/response pairs. Each request causes a relevant server module to be called, and the module outputs a response to each request. The server module maintains a session object (a software object modeling the session) for each active interaction with the user. The session object carries information between requests belonging to the same session. Each request is associated with a session object e.g. using cookies or URL (Uniform Resource Locator) rewriting.

Such a prior art arrangement for the Internet is disclosed, for example, in U.S. Pat. No. 5,961,601 to Arun Iyengar. The Iyengar patent discloses the use of continuations in connection with state preservation in web server applications. Iyengar defines a continuation as a new request which a client may send to a server. Whenever a client requests something from a server, the server may include one or more continuations in its response. When the server responds to a request, it may include one or more continuations which may be any valid requests. Iyengar defines a conversation as a sequence of communications between a client and server in which the server responds to each request with a set of continuations and the client always picks the next request from the set of continuations. In short, Iyengar basically defines a continuation as one possible way to continue a conversation. In FIG. 6, a double outline shows the program block in which state preservation is performed. State preservation according to Iyengar can be summarized as follows: 1) receive input; 2) produce output; 3) check if state preservation is needed 4) if yes, convert output by recursively embedding the state information in all identified continuations. Thus in the Iyengar mechanism, state information between the server S and the clients C is passed as modified HTML pages. The Iyengar approach involves three problems: firstly, the programmer must explicitly test if state preservation is needed and if yes, convert the output. Secondly, the Iyengar approach appears to preserve a state only when the user clicks links on HTML pages converted by Iyengar's invention but the state is not preserved if the user clicks the browser's forward or backward buttons. Thirdly, because the entire state information is stored in the converted HTML pages which are visible to the client computer, a skillful hacker may be able to modify the state information and possibly edit his access rights, etc.

The Iyengar approach belongs to a category known as URL rewriting (URL=Uniform Resource Locator). Another known technique to preserve a state employs cookies, which are essentially small data files saved to the disk of the client computer, the data files containing the state information. Similar to the Iyengar approach, an application program employing cookies must explicitly handle the cookies.

FIG. 7 shows a web application arrangement according to a preferred embodiment of the invention. The client hardware and software are exactly as in the prior art arrangement shown FIG. 6. A departure from the prior art is that state preservation is not performed explicitly by the application software AP but by the application interpreter AI. In the embodiment shown in FIG. 7, state preservation can be summarized as follows: 1) receive input; 2) produce output (using state-preserving function calls). In other words, the programmer only has to use a language (an application interpreter according to the invention) which implements state-preserving function calls. The application interpreter AI then preserves the program state automatically. Unlike the prior art arrangement, the arrangement according to the invention does not pass complete state information between the server S and the client C. Instead, state information is saved by the application interpreter AI, and only a small session and/or user identifier ID is passed between the server S and the client C to indicate the session to which a message (page request) relates. The client computer only sees an identifier ID which is far less vulnerable to hacking that the complete state information.

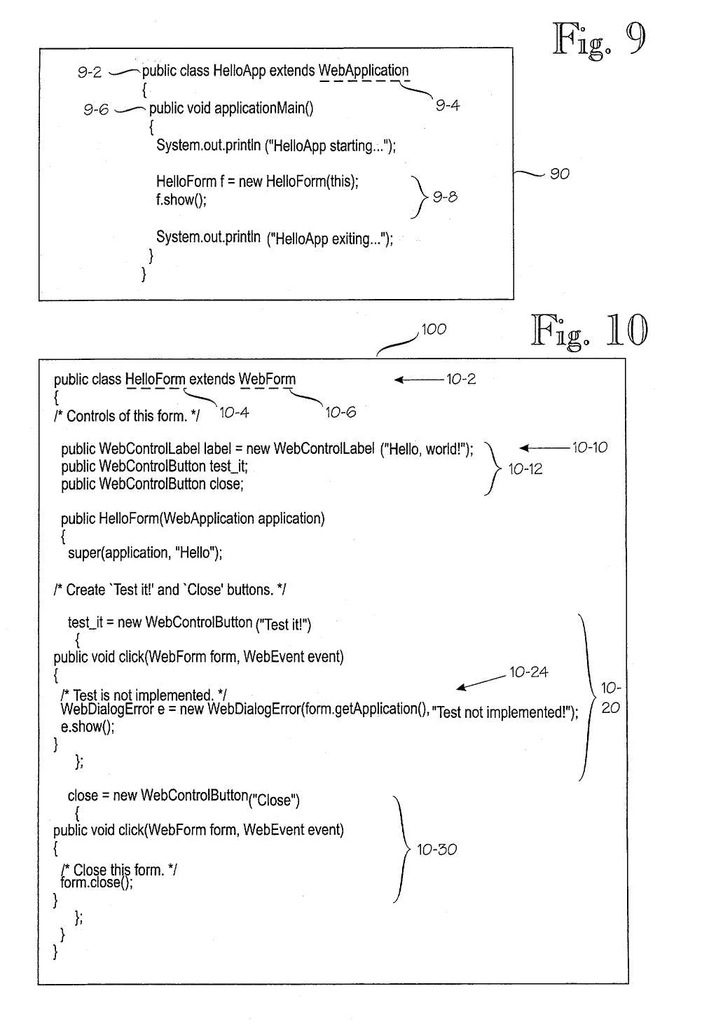

FIG. 9 shows a program listing 90 for a simple web application. On line 9-2, a new web application is created by extending the abstract WebApplication class 9-4 and by implementing the applicationMain( ) method 9-6. (The dashed underline under element 9-4 is not part of the program code but delineates the element which is denoted by the reference numeral.) In section 9-8, the applicationMain( ) method creates and displays an instance of a “HelloForm” class. When the user closes the form by pressing its close button, the show( ) method of the form returns and the applicationMain( ) method terminates. This terminates the HelloApp web application.

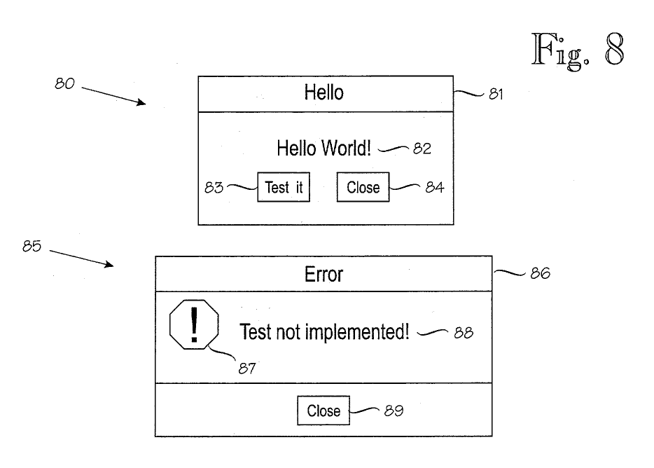

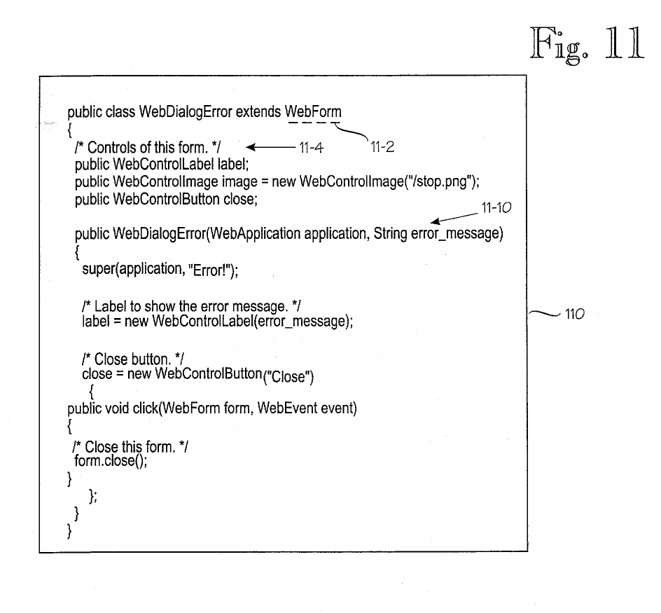

FIG. 10 shows a listing 100 for the implementation of the HelloForm. An example of such a form was shown as item 80 in FIG. 8. On line 10-2, the HelloForm class 10-4 is the main form of the HelloApp web application 90 shown in FIG. 9. When a new instance of the HelloForm is created, it is initialized in the constructor HelloForm( ) of the class. The constructor begins on line 10-10. In section 10-12, the constructor initializes its superclass WebForm and creates the controls of the form. The HelloForm 80 in FIG. 8 has three controls: a label 82 showing the text “Hello, world”, a “Test it!” button 83 and a “Close” button 84. Section 10-20 defines the logic underlying the “Test it!” button 83. When the “Test it!” button is pressed, a second form 85 opens an error dialog displaying an error message “Test not implemented” 88. Section 10-30 defines the logic underlying the “Close” button 89 of the second form 85. When the “Close” button 89 is pressed, the second form 85 is closed by calling the close( ) method of the form (program section 10-30).

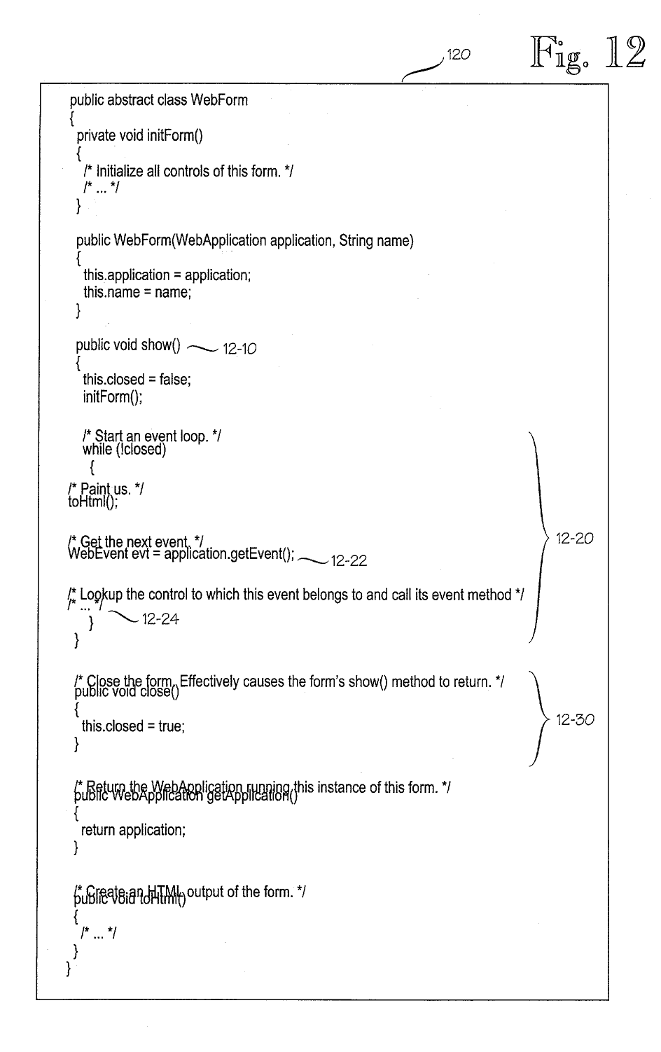

FIG. 11 shows a program listing 110 for implementing the error dialog. The program listing 110 is believed to be self-explanatory after the description of the two previous listings. The error dialog is initialized in the WebDialogError( ) constructor beginning on line 11-10. It initializes its superclass WebForm and, beginning on line 11-4, creates the controls of the form. In FIG. 11, item 11-2 denotes a reference to the Webform class, while the class itself is shown in FIG. 12. An example of such an error dialog form was shown as item 85 in FIG. 8. The error dialog has three controls: a label 88 showing the error message, an image 87 showing a stop sign, and a “Close” button 89 to close the dialog.

FIG. 12 shows a listing 120 for producing the abstract class “WebForm”. All forms can be created by producing new subclasses of the abstract WebForm class. The form is shown by calling its show( ) method, the definition of which begins on line 12-10. The show( ) method initializes the form and starts an event loop 12-20 that processes events for this form. The event loop is executed until the form is closed by calling the close( ) method 12-30 of the form.

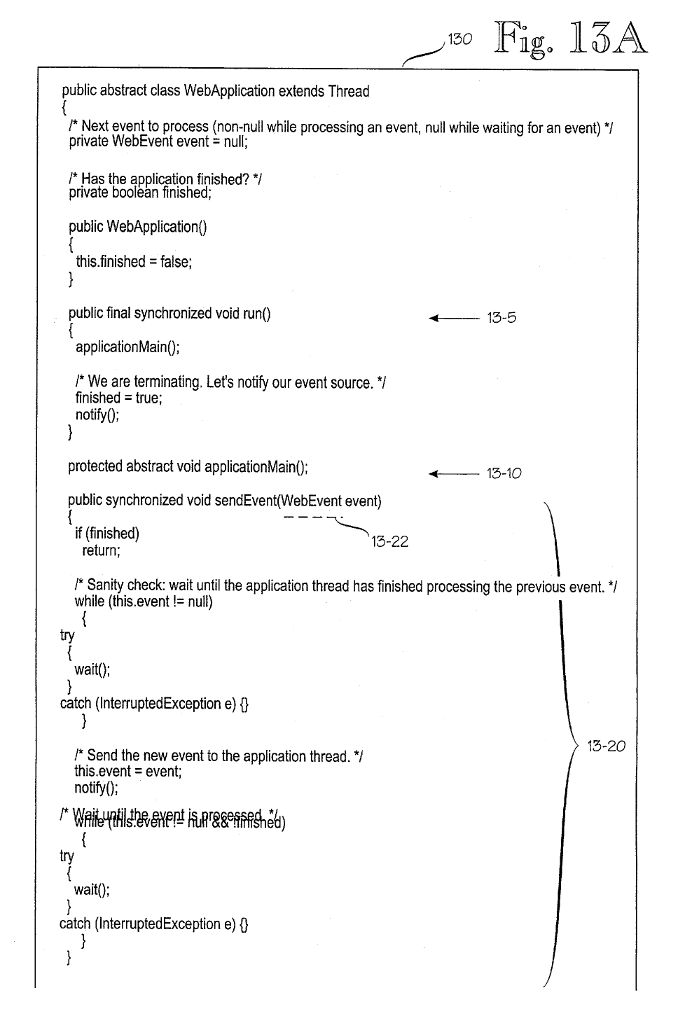

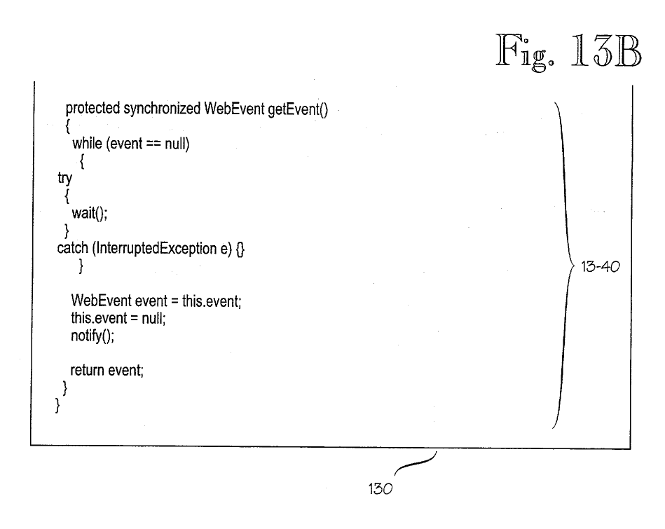

The event loop 12-20 is one way of suspending the execution of the thread while waiting for an external event, such as hardware action or the client's request to end the modal dialog. In the event loop 12-20, the application thread gets the next event by calling the application's getEvent( ) method on line 12-22. (The implementation of the actual thread will be described in connection with FIGS. 13A and 13B, in which the getEvent( ) method is shown as item 13-40). The getEvent( ) method waits until new input has arrived from the user of the application. When a new event occurs (new input arrives), the application thread determines the control to which the event should be sent. This determination takes place on line 12-24 but is not shown in detail. When the control is found, the application thread calls the event method of the control in question. The event methods are implemented in the control classes.

FIGS. 13A and 13B show a single logical listing 130 for an abstract web application class that is the superclass of all web applications. The instances of the web applications extend the Java Thread class so that each web application instance has a thread that executes the application. The main function of each thread is the run( ) method on line 13-5. On line 13-10, the actual web application class implements the applicationMain( ) method which is the main function of a web application. Line 13-10 begins the definition of the applicationMain( ) method.

The abstract web application class comprises two important methods, namely sendEvent( ) and getEvent( ). Section 13-20 is the definition of the sendEvent( ) method which is used by an event dispatcher (see FIG. 17) to send new events to the application. The sendEvent( ) method passes the WebEvent as a parameter 13-22 to the application and waits until the web application thread has finished processing the event. Section 13-40 defines the getEvent( ) method. The web application thread calls the getEvent( ) method to get a new event to process. It waits until a new event is available and after that, it processes the new event. After processing the event, it either gets a new event or terminates itself. The application termination takes place when the applicationMain( ) function 13-10 returns and the thread's main function run( ) 13-5 terminates.

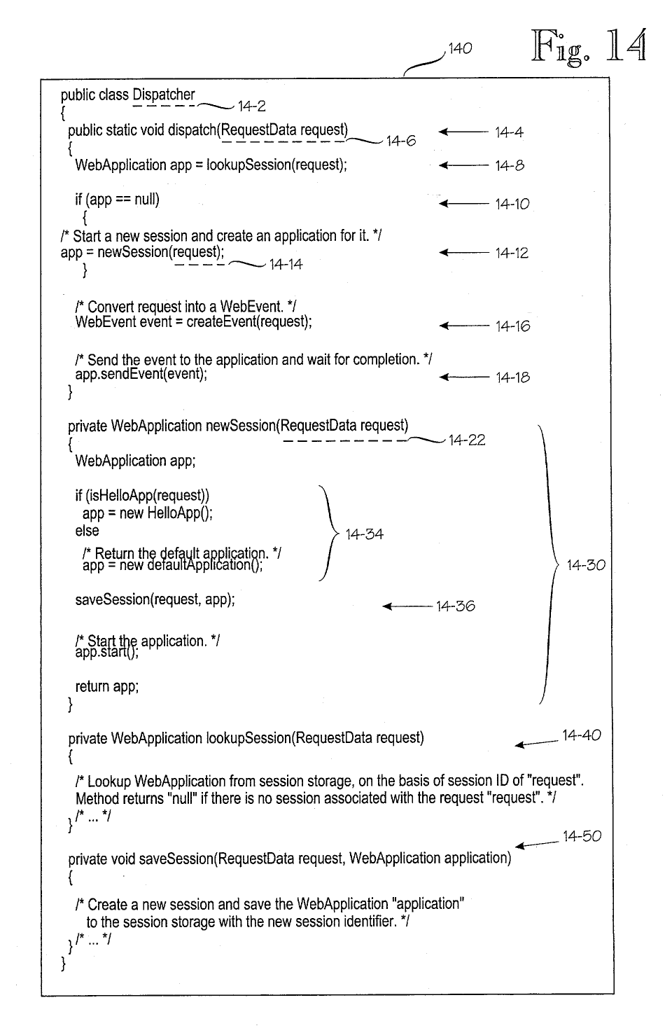

FIG. 14 shows a program listing 140 for the event dispatcher. The dispatcher class 14-2 implements the event dispatcher. On line 14-4, it is called with an argument “RequestData request” which contains the data 14-6 of the HTTP request. On line 14-8, the dispatcher tries to look up an existing session to which the request belongs. If an existing session is not found (the if test on line 14-10 fails), the dispatcher creates a new session and starts an application for it by calling the newSession( ) method on line 14-12. The newSession( ) method determines the type of the application from the request “request”, which is derived from parameter 14-6 and passed as parameter 14-14, and starts the appropriate web application.

When the web application is found, the dispatcher converts the HTTP request into a web event on line 14-16, and passes the event to the application by calling the application's sendEvent( ) method on line 14-18. The sendEvent( ) method returns when the application has processed the event. Section 14-30 defines a method called newSession( ) for starting new sessions. In its subsection 14-34, the method checks if the requested application is of the type “Hello”. If not, a new default application is started. The newSession( ) method also saves the newly created application object to the session storage by calling the saveSession( ) method on line 14-36.

Section 14-40 comprises a function for retrieving (looking up) a session on the basis of the session ID contained in the request 14-22. The actual look-up routine is not shown in detail but its construction is a straightforward task for those skilled in the art. As stated earlier, session retrieval can be based on a hash code, a balanced search tree and the like.

Section 14-50 comprises a function for saving the session with its session ID to the session storage. Similarly, the session-saving routine is not shown in detail because its construction is a straightforward task for those skilled in the art.

The invention has been disclosed in the form of concrete aspects, embodiments and features, but the invention is not limited to the examples shown. For example, the server shown in FIG. 7 can equally well be a wap (wireless application protocol) server instead of a web server. Likewise, many other modifications are apparent to a skilled reader without departing from the scope of the appended claims.

### References

In addition to the Iyengar patent (U.S. Pat. No. 5 961 601), reference is made to the following documents:

[FFKD87] Matthias Felleisen, Daniel Friedman, Eugene Kohlbecker, Bruce Duba: A syntactic theory of sequential control, Theoretical Computer Science 52:205-237, 1987.

[HF87] Christopher T. Haynes, Daniel Friedman: Abstracting timed preemption with engines, Journal of Computer Languages 12(2), pp. 582-598, 1987.

[KlShSm96] Steve Kleiman, Devang Shah, Bar Smaalders: Programming with Threads, SunSoft Press 1996.

[SF90] Dorai Sitaram and Matthias Felleisen: Control Delimiters and Their Hierarchies, Lisp and Symbolic Computation 3(1), pp. 67-99, 1990.

All of the above documents are incorporated herein by reference.

1. A method of application program execution within a computer system comprising an operating system providing an interface to external events, the operating system being essentially unmodifiable by the programmer of the application program;
the application program having at least one high-level language application program module which is modifiable by the programmer of the application program;
the operating system controlling the computer system most of the time and only intermittently dispatching control to the high-level language application program module, whereby the execution of the application program module is not sequential in a physical sense;
the method comprising the following steps under control of the high-level language application program module:
creating a thread for execution;
detecting a need for an asynchronous operation;
in response to a detected need, suspending the thread's execution;
detecting completion of the asynchronous operation;
in response to a detected completion of the asynchronous operation, resuming the thread's execution.

2. A method according to claim 1, wherein the suspending step comprises returning control to outside of the program module.

3. A method according to claim 1, wherein the suspending step comprises switching to another execution context.

4. A method according to claim 1, wherein the application program implements a server application for a data network.

5. A method according to claim 4, wherein the data network employs Internet protocol.

6. A method according to claim 4, wherein the data network employs Wireless Application protocol.

7. A method according to claim 1, wherein the need-detecting step comprises receiving HTTP request.

8. A method according to claim 1, wherein the execution-resuming step is responsive to a received HTTP request.

9. A method according to claim 1, wherein the high-level language is Java supplemented with instructions for implementing the steps of claim 1.

10. A method for implementing a modal dialog comprised in a session managed by a client-server application written in a high-level programming language, the method comprising the following steps to be carried out by the server:
creating an executable thread for the session comprising the modal dialog;
in response to an opening request from the client to open the modal dialog, outputting a page of the modal dialog to the client;
in connection with outputting the page to the client, suspending the thread's execution;
in response to a closing request from the client to close the modal dialog, resuming the thread's execution.

11. A method for testing hardware and/or software modules having at least one asynchronous interface with asynchronous function calls, the method comprising:
using a high-level language test application for performing a test operation, the test operation comprising creating an executable thread for an asynchronous function call;
converting the asynchronous function call to a synchronous function call by:
(a) suspending the execution of the thread when the test operation is started; and
(b) resuming the execution of the thread when the test operation is completed.

12. A high-level programming language for programming high-level application program modules, the language comprising:
a first instruction, instruction set or library function for creating an executable thread of a high-level application program module;
a second instruction, instruction set or library function for suspending the execution of the thread when the program module is waiting for an external event; and
a third instruction, instruction set or library function for resuming the execution of the thread when the external event occurs.

13. A programming language according to claim 12, wherein the external event is an HTTP request.

14. A programming language according to claim 12, wherein the programming language is Java.

15. A computer system for application program execution, the computer system comprising an operating system providing an interface to external events, the operating system being essentially unmodifiable by the programmer of the application program;
the application program having at least one high-level language application program module which is modifiable by the programmer of the application program;
the operating system being operable to control the computer system most of the time and only intermittently dispatch control to the high-level language application program module, whereby the execution of the high-level language application program module is not sequential in a physical sense;
the computer system further comprising:
a first software routine for creating a thread for execution;
a second software routine for detecting a need for an asynchronous operation;
a third software routine for suspending the thread's execution in response to a detected need;
a fourth software routine for detecting completion of the asynchronous operation;
a fifth software routine for resuming the thread's execution in response to a detected completion of the asynchronous operation.

16. A computer server system for implementing a modal dialog as a part of a session in a client-server application written in a high-level programming language, the computer server system comprising:
a first software routine for creating a thread for execution;
a second software routine for detecting a need for an asynchronous operation;
a third software routine for suspending the thread's execution in response to a detected need;
a fourth software routine for detecting completion of the asynchronous operation;
a fifth software routine for resuming the thread's execution in response to a detected completion of the asynchronous operation.

17. A computerized testing apparatus for testing hardware and/or software modules having at least one asynchronous interface with asynchronous function calls, the testing apparatus comprising:
a high-level language test program for performing test operations;
an instruction, instruction set or function library for converting asynchronous function calls to synchronous function calls by:
(a) suspending the execution of the thread when the test operation is started; and
(b) resuming the execution of the thread when the test operation is completed.

18. A computer-readable storage medium comprising a computer program set, wherein the execution of the program set in a computer causes the computer to carry out the steps of the method according to claim 1.

19. A computer-readable storage medium comprising a computer program set, wherein the execution of the program set in a computer causes the computer to carry out the steps of the method according to claim 10.

20. A computer-readable storage medium comprising a computer program set, wherein the execution of the program set in a computer causes the computer to carry out the steps of the method according to claim 11.
